(19) United States
(12) Patent Application Publication
(10) Pub. No.: US 2024/0380170 A1
(43) Pub. Date: Nov. 14, 2024

(54) METHOD AND LASER SYSTEM FOR GENERATING ULTRASHORT LASER PULSES HAVING STABLE PULSE PARAMETERS

(71) Applicant: TRUMPF Laser GmbH, Schramberg (DE)

(72) Inventors: Raphael Scelle, Villingen- Schwenningen (DE); Aleksander Budnicki, Waldkirch (DE); Florian Jansen, Villingen-Schwenningen (DE); Markus Ginter, Schramberg-Tennenbronn (DE); Jonathan Brons, Aichhalden (DE); Rainer Flaig, Eschbronn (DE)

(21) Appl. No.: 18/780,536

(22) Filed: Jul. 23, 2024

Related U.S. Application Data
(63) Continuation of application No. PCT/EP2022/083186, filed on Nov. 24, 2022.

(30) Foreign Application Priority Data
Jan. 25, 2022 (DE) 10 2022 101 644.7

(51) Int. Cl. H01S 3/00

(52) U.S. Cl. CPC H01S 3/0057; H01S 3/0085; H01S 3/0092

(57) ABSTRACT

A method for generating output laser pulses includes generating input laser pulses having an equal pulse duration, and coupling the input laser pulses into an optical actuator. A dispersion of the optical actuator is settable. The method further includes setting the dispersion of the optical actuator for a current input laser pulse, so that a pulse duration change caused by a change of a temperature of at least one component and/or by a change of an ambient temperature is compensated for, and that an associated output laser pulse has a pulse duration corresponding or nearly corresponding to a target pulse duration.

### CROSS REFERENCE TO RELATED APPLICATIONS

This application is a continuation of International Application No. PCT/EP2022/083186 (WO 2023/143773 A1), filed on Nov. 24, 2022, and claims benefit to German Patent Application No. DE 10 2022 101 644.7, filed on Jan. 25, 2022. The aforementioned applications are hereby incorporated by reference herein.

### FIELD

Embodiments of the present invention relate to a method for generating output laser pulses, and to a laser system suitable for carrying out the method.

### BACKGROUND

In general, a variation of the thermal load can have an effect on the behavior or the properties of optical, mechanical, or electronic components in laser systems. If such a behavior is observed when the laser system is switched on, it is also referred to as thermal run-in behavior of the laser system.

The inventors have recognized that in ultrashort pulse (USP) laser systems, in particular the pulse phase or pulse duration and thus the pulse peak power reacts sensitively to such changes of the component properties or the component behavior. Eliminating the thermal run-in in optics and mechanics is only possible partially and only with great technical expenditure, such as temperature control of the large number of optics using corresponding control/regulation.

### SUMMARY

Embodiments of the present invention provide a method for generating output laser pulses includes generating input laser pulses having an equal pulse duration, and coupling the input laser pulses into an optical actuator. A dispersion of the optical actuator is settable. The method further includes setting the dispersion of the optical actuator for a current input laser pulse, so that a pulse duration change caused by a change of a temperature of at least one component and/or by a change of an ambient temperature is compensated for, and that an associated output laser pulse has a pulse duration corresponding or nearly corresponding to a target pulse duration.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a laser system having a variable-dispersion stretcher and a free beam pulse compressor according to some embodiments;

FIG. 2a) shows a laser power of the laser system increased at the time t=0, according to some embodiments;

FIG. 2b) shows a gradual temperature increase of a base plate of the free beam pulse compressor by the laser power increased at the time t=0, according to some embodiments; and

FIG. 2c) shows a changing dispersion contribution of the free beam pulse compressor by the thermal expansion of the compressor baseplate and a change of the dispersion contribution of the variable-dispersion stretcher in order to obtain a constant pulse phase, which results in a constant pulse duration, according to some embodiments.

### DETAILED DESCRIPTION

Embodiments of the present invention provide pre-compensating or compensating for the thermal run-in behavior depending on the thermal load.

According to embodiments of the invention, a method for generating output laser pulses, in particular USP laser pulses, the pulse duration of which is dependent on the temperature of at least one component and/or on an ambient temperature, having equal or nearly equal target pulse duration, comprising the following method steps:
generating input laser pulses in particular having equal pulse duration,
coupling the input laser pulses into an optical actuator, the dispersion of which is settable, and
setting the dispersion of the optical actuator for a current input laser pulse such that a pulse duration change caused by the at least one component and/or the surroundings is compensated for and the associated output laser pulse has a pulse duration corresponding or nearly corresponding to the target pulse duration.

According to embodiments of the invention, the thermally induced pulse duration change is pre-compensated or compensated by a actuator (such as adaptation of the compressor or stretcher phase) depending on the thermal load.

In one preferred method variant, the dispersion of the optical actuator to be set for the current input laser pulse is determined on the basis of the current thermal load of the at least one component and on the basis of the history of the thermal load of the at least one component. For example, the current thermal load of the at least one component can be determined on the basis of the mean power of the current output laser pulses and the history of the thermal load of the at least one component can be determined on the basis of the mean power of the respective preceding output laser pulses. The dispersion to be set can be determined, for example, progressively from modeling of the pulse phase as a function of the temperature of the at least one component or beforehand on the basis of a previously known sequence of output laser pulses.

Preferably, the dispersion of the optical actuator to be set for the current input laser pulse is determined on the basis of at least the last input pulses preceding the current input laser pulse and/or on the basis of a target dispersion value for a settled state of the at least one component in which the temperature of the at least one component is essentially constant over time. The control signal of the actuator advantageously only takes into consideration for a specific output laser pulse those preceding laser pulses which have significantly contributed to the current heating of the component. Alternatively, however, all preceding laser pulses can also be taken into consideration.

Preferably, the dispersion of the optical actuator to be set for the current input laser pulse is determined from a target value for the settled state of the at least one component and from a sum of correction values which is determined in consideration of at least the last preceding input pulses. The correction values can be determined, for example, progressively from modeling of the pulse phase as a function of the temperature of the at least one component or beforehand on the basis of a previously known sequence of output laser pulses.

The deviation of the pulse duration of the output laser pulses from the target pulse duration is advantageously less than 10%, preferably less than 2%.

Embodiments of the present invention also relate to a laser system for generating output laser pulses, in particular ultrashort output laser pulses, having equal or nearly equal target pulse duration at an output, comprising:
an excitation laser for generating input laser pulses in particular having equal pulse duration,
at least one component and/or surroundings (such as air), which contributes to the thermal dependence of the pulse duration of the output laser pulses, an optical actuator arranged between the excitation laser and output, the dispersion of which is settable, and
a controller, which is programmed or configured to carry out the method according to embodiments of the invention.

The optical actuator is preferably designed as a variable, in particular temperature-controllable stretcher lattice (pulse stretcher) for stretching the input laser pulses, as a dispersion changing element (for example made of glass) arranged in a pulse compressor, as a liquid crystal element, or as a movable element, in particular a lattice or prism, of a pulse compressor.

The at least one component is preferably an amplifier for amplifying the input laser pulses. At least one preamplifier, preferably a first preamplifier and a second preamplifier, can be arranged upstream of the amplifier, wherein the optical actuator is advantageously arranged between the excitation laser and amplifier, preferably between the excitation laser and the first preamplifier.

A pulse selection unit (“pulse picker”), in particular an acoustooptical modulator (AOM) or an electro-optical modulator (EOM) is preferably arranged downstream from the excitation laser to let through selected ones of the input laser pulses in the direction of the output. The pulse selection unit is preferably arranged between the excitation laser and an amplifier, preferably between a first preamplifier and a second preamplifier.

For a frequency conversion of the input laser pulses, a nonlinear optical crystal can be arranged upstream of the output, in particular between an amplifier and the output. For a compression of the input laser pulses, a pulse compressor, in particular a grating compressor, can be arranged upstream of the output, in particular between an amplifier and the output.

The at least one component is preferably an optical component through which the input pulses pass, or a mechanical or electrical component which is heated during the generation of the output laser pulses. The optical component is in particular heated by the input pulses passing through it. The mechanical or electrical component is heated, for example, by waste heat and/or scattered light.

Embodiments of the invention also relate to a control program product which has code means that are adapted to carry out all steps of the method according to embodiments of the invention when the program runs on a controller of the laser system according to embodiments of the invention.

The features mentioned above and those yet to be explained further can be used in each case individually or together in any desired combinations. The embodiments shown and described should not be understood as an exhaustive enumeration, but rather are of an exemplary character for describing the invention.

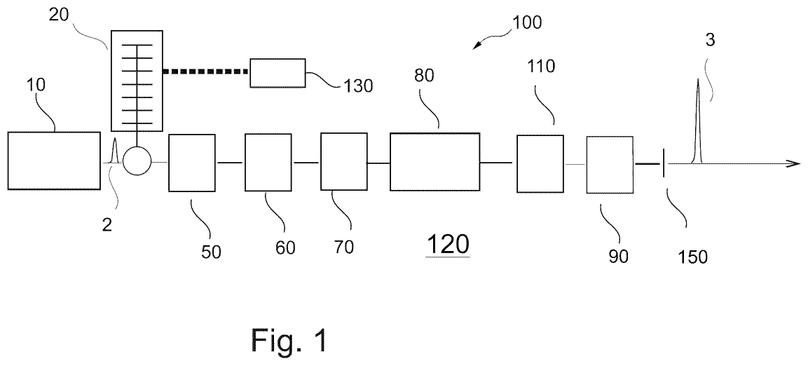

FIG. 1 shows a schematic representation of a USP laser system 100 for generating output laser pulses 3 at the output 150 of the laser system. The laser system has an excitation laser 10, which is configured for generating input laser pulses 2, and an amplifier 80, which is configured for amplifying laser light. The laser system 100 additionally has, in the light propagation direction after the excitation laser 10, a pulse stretcher 20 for stretching the laser pulses, an optional first preamplifier 50, an optional second preamplifier 70, and an optional pulse compressor 110, in particular a grating compressor, for compressing the laser pulses. Furthermore, the laser system 100 additionally has an optional pulse selection unit 60 (e.g., an acousto-optical modulator (AOM) or electro-optical modulator (EOM)), which is arranged here between the first preamplifier 50 and the second preamplifier 70. The laser system 100 optionally has a nonlinear optical crystal 90 for frequency conversion, thus the wavelength of the laser light.

Furthermore, the laser system 100 has a controller 130 for actuating the laser system 100. In this case, the controller 130 is designed such that it emits a signal at an actuator 20 in order to compensate or pre-compensate for the effect of the thermal load of the laser system 100 on the pulse duration or pulse phase. The actuator 20 is designed as an element having variable dispersion and is arranged in the laser system 100 between excitation laser 10 and laser output 150. In the example shown, the actuator 20 is embodied as a pulse stretcher and/or as a variable stretcher grating. The controller 130 is designed such that the method described hereinafter for actuating the laser system 100 can be carried out in order to keep the pulse duration essentially stable. The laser system 100 can have further elements not explicitly listed here, which are routine for a person skilled in the art to design an amplifier system.

The actuator 20 is designed as an element having variable dispersion and can be designed as a variable, in particular temperature-controllable stretcher grating, as a dispersion changing element arranged in the compressor, as described in DE 10 2016 110 947 A1, in particular as a glass block, as a liquid crystal element, or as a movable element of the compressor, in particular a movable grating or prism.

The optical components 50, 60, 70, 80, 90, 110 having thermally dependent behavior can in particular be a nonlinear crystal, a grating, a mirror, and/or other temperature-sensitive components which are arranged in the laser system 100 and heat up as an input laser pulse passes through and/or due to thermal waste heat or reflections from other components and thus contribute to the thermal dependence of the pulse duration.

Mechanical components having thermally dependent behavior can in particular be mounts for optical units and baseplates, which heat up due to thermal waste heat or reflections from other components.

Electronic components having thermally dependent behavior can in particular be control circuit boards of the controller, which heat up due to thermal waste heat or reflections from other components or intrinsic waste heat.

The preamplifiers 50, 70 can have a fiber, a rod, a slab, a disk, or a plate as the amplification medium.

The amplifier can have a fiber, a rod, a slab, a disk, or a plate as the amplifier medium.

To carry out the method, the controller 130 is designed such that a control signal is generated in order to actuate the actuator 20 for a current input laser pulse 2 such that the associated output laser pulse 3 has a pulse duration which essentially corresponds to the specified pulse duration. The control signal can consist of a target value for the settled state of the laser system 100 and a sum of correction values which are determined as described below in consideration of all input pulses 2 preceding the current input laser pulse or in consideration of only those preceding last input pulses 2 which have significantly contributed to the current heating of the component.

The settled state of the laser system 100 is understood as a state in which the temperature of the laser system 100 and/or the temperature of the components of the laser system is essentially constant over time.

Essentially stable pulse duration is understood in the scope of this application to mean that the pulse duration deviation from the target value pulse duration is less than 10%, preferably less than 2%.

In the method for actuating the laser system 10, the correction values for compensation are dynamically determined or calculated and result from modeling of the pulse phase as a function of the thermal load.

The temperature difference ΔT_{K}(t) of a component 50, 60, 70, 80, 90, 110 and/or the surroundings 120 of a laser system relative to the cold state may be described by a differential equation and represents a starting value problem.

$$( d Δ {T}_{K} ) / dt = - ( Δ {T}_{K / τ K} ) + {h}_{k} ( t ) \qquad ( 1 )$$

τ_{K} and h_{K}(t) designate an intrinsic time constant or a heating term and have to be known to solve for ΔT_{K}(t).

In general, the heating term h_{K}(t) is a function f of the laser power P(t), which results from the pulse energies and the repetition rate of the laser:

$${h}_{K} ( t ) = f ( P ( t ) ) \qquad ( 2 )$$

In most cases, the relationship is linear in a first approximation:

$${h}_{K} ( t ) = {a}_{h} * P ( t ) \qquad ( 3 )$$

The temperature of a component 50, 60, 70, 80, 90, 110 can influence its properties or its behavior. A temperature change as a result can in turn influence the pulse phase. For example, a temperature change can induce a length change by means of thermal expansion. In the case of a free beam compressor, a change of the optical path between the compressor gratings results in a change of the compressor dispersion and thus a change of the pulse phase of the pulse passing through.

The change of the pulse phase (phase contribution) by a component 50, 60, 70, 80, 90, 110 relative to the cold state is dependent on the temperature difference from the cold state, thus is a function of the temperature difference:

$${Δϕ}_{K} ( t ) = g ( Δ {T}_{K} ( t ) ) \qquad ( 4 )$$

The relationship is again linear in a first approximation:

$$Δ {ϕ}_{K} ( t ) = {a}_{ϕ} * Δ {T}_{K} ( t ) \qquad ( 5 )$$

To stabilize the pulse duration or the pulse phase of an ultrashort pulse laser, the overall phase change ΔØ, thus the phase contributions of all relative components, has to be compensated for via an actuator:

$$Δϕ ( t ) = {\sum }_{K} {Δϕ}_{K} ( t ) \qquad ( 6 )$$

For the compensation, it is thus necessary to dynamically solve equations (1), (2), and (4) or, with linear approximation, (1), (3), and (5) for all relevant components and to apply a phase to the laser pulse using the actuator which is inverse to the phase from equation (6). If the future time curve of the laser power is known, the equations can alternatively be solved beforehand in order to calculate the time curve of the phase change.

The equations can be solved numerically, thus discretized. The intrinsic time constants τ_{K}, the functional relationships between heating term h_{K}(t) and laser power P(t) and temperature difference ΔT_{K}(t) and change of the pulse phase ΔØ_{K} have to be known to solve the equations and can be determined via measurement (for example upon acceptance of the laser system) or calculation.

In principle, the actual component temperature is not of interest, but only the effect of the thermal load (laser power) on the phase contribution of the component. Instead of solving the differential equation (1), it is also possible by combining equation (4) and (1) to set up a differential equation for the phase contributions and solve it. This procedure can reduce the number of the parameters to be determined. For linear relationships between laser power and heating term (equation (3)) and a linear relationship between phase contribution and component temperature (equation (5)), the following results:

$$( d Δϕ K ) / dt = - ( {Δϕ}_{K / τ K} ) + a * P ( t ) \qquad ( 7 )$$

Alternatively to the continuous solution of the differential equation (1) for all relevant components and calculation of the phase change ΔØ(t) (6), it is possible to calculate the phase change ΔØ(t) as accurately as possible by a parameterizable function as a function of the laser power P(t):

$$Δϕ ( t ) = k ( P ( t ) ) \qquad ( 8 )$$

and to compensate for the phase change via the actuator accordingly.

The parameters of this function can be determined by measuring the thermal run-in or by minimizing the thermal run-in. In general, it is advisable to select a function which reflects the behavior of the differential equation (1) as well as possible. For a rapid increase of the laser power, for example, a function of the following form is suitable:

$$Δϕ ( t ) = {\sum }_{K} {a}_{k} * {P}_{0} * ( 1 - {e}^{t / τ K} ) \qquad ( 9 )$$

The method according to embodiments of the invention for generating output laser pulses 3, in particular ultrashort output laser pulses, the pulse duration of which is dependent on the temperature of at least one component 50, 60, 70, 80, 90, 110 and/or on an ambient temperature, having equal or nearly equal target pulse duration, comprises the following steps:
generating input laser pulses 2, in particular having equal pulse duration,
coupling the input laser pulses 2 into an optical actuator 20, the dispersion of which is settable, and
setting the dispersion of the optical actuator 20 for a current input laser pulse 2 such that a pulse duration change caused by the at least one component 50, 60, 70, 80, 90, 110 and/or by the surroundings 120 is compensated for and the associated output laser pulse 3 has a pulse duration corresponding or nearly corresponding to the target pulse duration.

Preferably, the dispersion of the optical actuator 20 to be set for the current input laser pulse 2 is determined on the basis of at least the last input pulses 2 preceding the current input laser pulse 2 and/or on the basis of a target dispersion value for a settled state of the at least one component 50, 60, 70, 80, 90, 110, in which the temperature of the at least one component 50, 60, 70, 80, 90, 110 is essentially constant over time. The dispersion of the optical actuator 20 to be set for the current input laser pulse 2 can be determined from a target value for the settled state of the at least one component 50, 60, 70, 80, 90, 110 and from a sum of correction values which is determined in consideration of at least the last preceding input pulses 2. The correction values can be determined, for example, progressively from modeling of the pulse phase as a function of the temperature of the at least one component 50, 60, 70, 80, 90, 110 or beforehand on the basis of a previously known sequence of output laser pulses 3.

The method according to embodiments of the invention for generating ultrashort output laser pulses 3, the pulse duration of which is dependent on the temperature of at least one component, having equal or nearly equal target pulse duration is described hereinafter on the basis of the example of a USP laser system 100 having a settable fiber Bragg grating as the stretcher 20 and a free beam pulse compressor 110.

The laser system 100 is first off for a long time (cold state) and is then switched on. Due to the switching on of the excitation laser 10, it heats up and a baseplate of the pulse compressor 110 becomes warm. Due to the heating of the baseplate of the pulse compressor 110, the distance between the compressor gratings increases due to the thermal expansion. A change of the pulse phase of the pulse running through the pulse compressor 110 relative to the cold state results therefrom. The change of the pulse phase is compensated for by the settable stretcher 20.

For the compensation, the functional relationship of equations (2) and (4) is linearly approximated, and the parameters τ_{K}, aₕ, and a_{Ø} are determined beforehand, for example, by measuring the run-in behavior.

In this example, the phase to be compensated may be analytically solved. If the laser system 100 was off for t<=0 a longer time, i.e.,
P(t)=0 for t<=0
ΔT_{K}(t)=0 for t<=0
   and is switched on at the time t=0, i.e.,
P(t)=P₀ for t>0,
   the following results for the temperature difference of the base plate of the pulse compressor 110 relative to the cold state from equations (1) and (3)

$$Δ {T}_{K} ( t ) = {a}_{h} * {P}_{0} * {τ}_{K} * ( 1 - {e}^{t / τ K} )$$

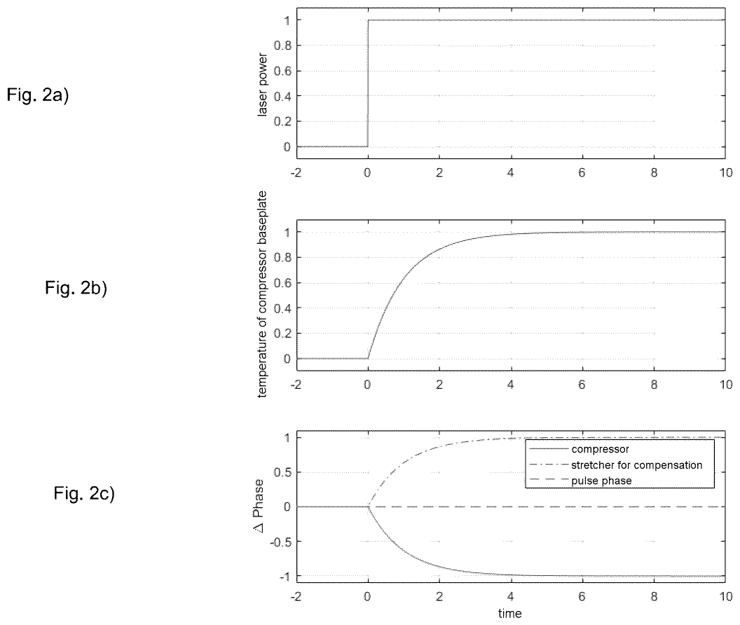

and for the phase (FIG. 2c) to be compensated

$$Δ ϕ ( t ) = {a}_{ϕ} * {a}_{h} * {P}_{0} * {τ}_{K} * ( 1 - {e}^{t / τ K} )$$

FIG. 2a) shows a laser power of the laser system 100 increased at the time t=0, which results in a gradual temperature increase of the base plate of the pulse compressor 110 (FIG. 2b)). The solid line in FIG. 2c) shows a changing dispersion contribution of the pulse compressor 110 due to the thermal expansion of the base plate of the pulse compressor 110 and a change of the dispersion contribution of the variable-dispersion stretcher 20 (dot-dash line), in order to obtain a constant pulse phase (dashed line), which results in a constant pulse duration.

For the control signal, a correction value is calculated for at least one temperature-sensitive component 50, 60, 70, 80, 90, 110 which contributes to the thermal dependence of the pulse duration and offset with the target value. Multiple temperature-sensitive components 50, 60, 70, 80, 90, 110 which contribute to the thermal dependence of the pulse duration can be present in a laser system 100. This results in a control signal which contains a target value and a correction value that contains multiple correction terms, in particular a correction term for each temperature-sensitive component.

The dispersion of the optical actuator 20 to be set for the current input laser pulse 2 can also be determined on the basis of the current thermal load of the at least one component 50, 60, 70, 80, 90, 110 and on the basis of the history of the thermal load of the at least one component 50, 60, 70, 80, 90, 110. The respective current thermal load of the at least one component 50, 60, 70, 80, 90, 110 and the history of the thermal load of the at least one component 50, 60, 70, 80, 90, 110 are determined, for example, on the basis of the mean power of the respective preceding output laser pulses 3.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for generating output laser pulses, the method comprising:
generating input laser pulses having an equal pulse duration,
coupling the input laser pulses into an optical actuator, wherein a dispersion of the optical actuator is settable, and
setting the dispersion of the optical actuator for a current input laser pulse, so that a pulse duration change caused by a change of a temperature of at least one component and/or by a change of an ambient temperature is compensated for and that an associated output laser pulse has a pulse duration corresponding or nearly corresponding to a target pulse duration.

2. The method as claimed in claim 1, wherein the dispersion of the optical actuator to be set for the current input laser is determined based on a current thermal load of the at least one component and on a history of thermal load of the at least one component.

3. The method as claimed in claim 2, wherein the current thermal load of the at least one component is determined based on a mean power of the current output laser pulses, and the history of thermal load of the at least one component is determined based on a mean power of respective preceding output laser pulses.

4. The method as claimed in claim 2, wherein the dispersion of the optical actuator to be set is progressively determined from modeling of a pulse phase as a function of the temperature of the at least one component, or is determined beforehand based on a previously known sequence of output laser pulses.

5. The method as claimed in claim 1, wherein the dispersion of the optical actuator to be set for the current input laser pulse is determined based on last input laser pulses preceding the current input laser pulse, wherein the last input laser pulses have passed through the at least one component, and/or based on a target dispersion value for a settled state of the at least one component, wherein in the settled state, the temperature of the at least one component is essentially constant over time.

6. The method as claimed in claim 5, wherein the dispersion of the optical actuator to be set for the current input laser pulse is determined from the target dispersion value for the settled state of the at least one component and from a sum of correction values determined in consideration of at least the last preceding input laser pulses.

7. The method as claimed in claim 6, wherein the correction values are determined progressively from modeling of a pulse phase as a function of the temperature of the at least one component, or are determined beforehand based on a previously known sequence of output laser pulses.

8. The method as claimed in claim 1, wherein a deviation of the pulse duration of the output laser pulses from the target pulse duration is less than 10%.

9. The method as claimed in claim 8, wherein the deviation of the pulse duration of the output laser pulses from the target pulse duration is less than 2%.

10. A laser system for generating output laser pulses, the laser system comprising:
an excitation laser for generating input laser pulses having an equal pulse duration,
at least one component and/or a surrounding,
an optical actuator arranged between the excitation laser and an output, wherein a dispersion of the optical actuator is settable, and
a controller programmed to carry out the method as claimed in claim 1.

11. The laser system as claimed in claim 10, wherein the optical actuator comprises a temperature-controllable stretcher grating for stretching the input laser pulses, or a dispersion changing element arranged in a pulse compressor.

12. The laser system as claimed in claim 10, wherein the optical actuator comprises a movable element of a pulse compressor, the movable element being a grating or a prism.

13. The laser system as claimed in claim 10, wherein the at least one component is an amplifier for amplifying the input laser pulses.

14. The laser system as claimed in claim 13, further comprising a first preamplifier and a second preamplifier arranged upstream of the amplifier.

15. The laser system as claimed in claim 14, wherein the optical actuator is arranged between the excitation laser and the first preamplifier.

16. The laser system as claimed in claim 10, further comprising a pulse selection unit for letting through selected ones of the input laser pulses, wherein the pulse selection unit is arranged downstream from the excitation laser in a direction of the output.

17. The laser system as claimed in claim 10, further comprising a nonlinear optical crystal for frequency conversion of the input laser pulses, wherein the nonlinear optical crystal is arranged upstream of the output.

18. The laser system as claimed in claim 10, further comprising a pulse compressor for compressing the input laser pulses, wherein the pulse compressor is arranged upstream from the output.

19. The laser system as claimed in claim 10, wherein the at least one component is an optical component, through which the input laser pulses pass, or is a mechanical or electrical component, which is heated during the generation of the output laser pulses.

20. A non-transitory computer-readable medium having program steps stored thereon, the program steps, when executed by a computer processor, causing performance of the method as claimed in claim 1.
